(19) United States
(12) Patent Application Publication
(10) Pub. No.: US 2003/0222900 A1
(43) Pub. Date: Dec. 4, 2003

(54) Computer assisted and/or implemented process and system for selecting, storing, and retrieving slides and slidekits, including to a personal folder, for healthcare providers

(75) Inventors: Susan Schramm-Apple, Hatfield, PA (US); Sean Dippold, Schwenksville, PA (US); Melanie Kittrell, Maple Glen, PA (US); Keith Bauer, Souderton, PA (US); Lori Moore, Lafayette Hill, PA (US)

Correspondence Address: HALE & DORR LLP, THE WILLARD OFFICE BUILDING, 1455 PENNSYLVANIA AVE, NW, WASHINGTON, DC, 20004, US

(73) Assignee: Merk & Co., Inc., Rahway, NJ (US)

(21) Appl. No.: 10/390,162

(22) Filed: Mar. 18, 2003

Related U.S. Application Data
(60) Provisional application No. 60/364,743, filed on Mar. 18, 2002.

(51) Int. Cl. G09G 5/00

(52) U.S. Cl. 345/730

(57) ABSTRACT

The invention provides a method, system, and computer program device for allowing users to preview and/or choose one or more slides and slidekits to be incorporated into a professional presentation. Intended users include physicians and other healthcare providers. Slidekits are displayed by medical categories to which they are assigned. Each slidekit includes a series of interrelated slides concerning a particular medical topic. Each slide may include lecture notes, in addition to a thumbnail image, full image display, title, and/or brief description. Slides and/or slidekits may be downloaded to the user's remote computer, for further incorporation into a presentation, printed by the user, or stored in the user's folder. The user's folder also may be used to store other folders and/or bookmarks to internal or external pages. Optionally, the user's right to access the slidekits and/or external sites is verified.

### RELATED APPLICATIONS

This application claims priority to U.S. Provisional Patent Application No. 60/364,743, “Computer Implemented and/or Assisted Process and System for MerckMedicus” filed Mar. 18, 2002, incorporated herein by reference.

This application is related to the following U.S. Patent applications: Attorney docket numbers 105456.121, 105456.123, 105456.124, 105456.126, and 105456.127, to the same inventors, and all of which are incorporated herein by reference.

### BACKGROUND OF THE INVENTION

1. Field of the Invention

The present invention is directed to computer related and/or assisted systems, methods, and computer program devices for selecting, storing, and retrieving slides and slidekits in the medical field. More particularly, it relates to methods and systems for selecting slides and/or slidekits from, for example, previously prepared slidekits, and saving in a personal folder, downloading, or printing the selected slides and/or slidekits, for use in presentations by healthcare professional users, e.g., physicians and other healthcare providers.

2. Description of the Related Art

In the healthcare field, healthcare professionals conventionally may obtain information from medical publishers, with most of this information being just in print. On the other hand, academic institutions have considerable libraries, which unfortunately are not universally available to physicians. Hence, paper resources with healthcare information may be considerable but difficult to access.

In an attempt to provide information electronically, early websites with limited information were sponsored by a variety of commercial entities, academic institutions, or medical associations. There was, nevertheless, a lack of awareness among physicians of the web as a resource for providing information and/or other resources needed by physicians.

These conventional means of providing information and other healthcare professional resources resulted in an uneven playing field for healthcare providers. In addition, there are a number of other hurdles facing office-based, rural and non-institutional healthcare professionals.

Physicians and other healthcare providers are presently adapted to the current situation. They are unlikely to change their current habits. Although there is a much greater degree of information available, unfortunately it will not find its way into the hands of physicians and healthcare providers, and ultimately will not result in improved healthcare. Nevertheless, the ability to save time and/or money is one of the primary motivators for physicians or healthcare professionals to change their habits.

Conventionally, the information and/or information gathering process is difficult and awkward for healthcare providers. The information might not be provided in one convenient place. Moreover, the information itself might be inconvenient. For example, if the information is provided by subscription, it is typically expensive to obtain multiple subscriptions. On the other hand information in textbooks might not be up-to-date. Further, textbooks, journals and libraries are not at all suited to physicians' nomadic working style, which typically includes travel between an office and a hospital. Information that might be provided over the web may be jumbled or confused, with multiple places, passwords, formats, browsers and search engines provided for a variety of information. Ultimately, physicians and other providers have entirely too many subscriptions, accounts, ID's and passwords, making the information awkward.

With regard to utilizing the Internet, the physicians might suspect the quality of information or services provided online. Moreover, such information and services might be biased, for example as a result of a sponsor of a particular product, unbeknownst to the users. Where information stored in sites is searchable, the search engines that are provided might not retrieve search results that are most relevant to the physician's query.

In some situations, the access to information or services might be tied to a specific license or specialized access technology. For example, in order to obtain certain information or services, the physician might be required to use a specific computer or install certain technology.

In addition, sites that are provided by pharmaceutical companies do not tend to focus on physicians. These sites are product driven and patient oriented. They fail to provide for the needs of the physician as a customer. In short, it is difficult to obtain information or services via conventional methods.

One specific example of a website directed to physicians is Medscape/WebMD. However, Medscape/WebMD is commercially sponsored, and therefore exhibits a bias. As another example, this site gives physicians limited access to premium resources, such as the best journals and text, because there is no financial incentive to make this information available. Moreover, typical of these types of sites, Medscape/WebMD does not have access to the premium resources sufficient to place them online.

Meanwhile, physicians are facing an increasing number of pressures. These pressures on healthcare practitioners include an increase in time pressures, perhaps caused by busy practices and overwhelming paperwork. At the same time, healthcare practitioners face decreasing practice revenues. They also face information overload, with a decreasing amount of time to sort through the relevant information.

The inventors have determined that physicians or other healthcare professionals engage in a number of online activities, including literature searches, reading medical news in the professional press, reading professional journals, finding patient educational materials, using drug reference databases, researching upcoming meetings, engaging in online continuing medical education (CE), reading medical news in the lay press, communicating with colleagues, finding out about clinical trials, learning about medical devices, reading medical text, and/or participating in MD chat rooms. It is estimated by the inventors that online CE is engaged in by 58% and 51% of primary care providers and physician specialists, respectively.

The inventors have determined that physicians refer to medical information sites primarily to find news and reference materials. In one study by the inventors in responding to a question about the three most important factors a physician uses in determining which medical information sites to use, the following responses were provided:

| Description | Percent |
|---|---|
| Medline Literature Search | 64% |
| Medical News Updates and Alerts | 53% |
| Medical Journals | 47% |
| Drug Reference Database | 34% |
| Medical Textbooks | 30% |
| Continuing Education Online Courses | 29% |
| Patient Relationship Information and | 20% |
| Guides | |
| Clinical Trial Information and Links | 15% |
| Listing of Medical Organizations and | 7% |
| Meetings | |
| Financial and World News | 5% |
| Community and Messages Boards | 4% |

The inventors performed extensive research with physicians about website features and functionality, including advisory boards, one-on-ones and online user ability testing. The above table highlights the findings of the online usability test of 154 physician respondents.

According to the Online Physician Market Dynamics Study (ZIMENT), February/March 2001, (Q9), quality, credibility and ease of use are the most important features to physicians in an online service. The following are attributes that are important to specialists and primary care physicians:

Provides credible information

Provides quality information

Is easy to use*

Provides up-to-date health and medical information*

Enables effective research of usual cases or conditions

Is comprehensive

Offers premium medical resources not easily accessible elsewhere

Helps physicians communicate better with patients

Is available to doctors only and not general consumers

Offers ability to customize site based on preferences or specialty

Has a professional look and feel

Is unique from other sites

(* These attributes are less important to specialists than primary care physicians.)

Certain aspects of conventional systems for providing healthcare information are illustrated by way of example in FIG. 1, also described in U.S. Pat. No. 5,917,480, Tafoya et al., incorporated herein by reference. Tafoya discloses a system with a slide-show mode screen display and an edit mode screen display, e.g. Powerpoint™ A user creates a set of presentation slides and then subsequently delivers the presentation on the screen display 170. As illustrated in FIG. 1, in the slide-show mode, a slide 172 is displayed on the entire viewing area of the monitor 136. The slide-show mode allows the user to step through the entire presentation in a professional and polished manner. In the edit mode, the display 170 includes an edit-mode control window 174 including control items 175a through 175n, which are relatively small so that a relatively large number of control items may be provided within the edit-mode control window 174. The standard Powerpoint™ edit-mode control window, for instance, includes over sixty control items. The edit-mode control window 174 is displayed on a portion of the monitor 136 in front of the computer's desktop display and desktop display items 176a through 176n thereon. In addition, the edit-mode control window 174 includes a viewing field 178. The user may select among editing modes: slide-view, outline-view, slide-sorter, and notes-view. Each editing mode corresponds to a different display of information within the viewing field 178. For example, in the notes-view mode, the user may create and view speaker's notes for each slide. For example, a speaker's note 179 associated with a slide 172 may be displayed under the slide within the viewing field 178. The edit mode screen display 170 is considerably cluttered. As disclosed in Tafoya, invoking the edit mode during a presentation is distracting to the audience.

Other aspects of conventional systems are illustrated by way of example in FIG. 2, also described in U.S. Pat. No. 6,397,036, Thean et al., incorporated herein by reference. Thean discloses a collaborative learning system, method and computer program that includes pre-event, event, and post-event stages. FIG. 2 illustrates a display screen, created by the producer and presenter, and viewed by the audience over the worldwide web or on a micro-site. The display screen includes a number of areas, such as a slide 201; an area for the audience to ask questions 202 by typing in the question and submitting to the presenter; a listing of slides 203; advertising and other information 204; and a “chat” command 205 for entering a “chat” session with the presenter.

The above prior art references, however, fail to meet the needs of today's medical community. For example, we have determined that physicians and healthcare professionals would prefer a website with cutting edge tools and resources, available in a single portal, as a key to the medical Internet. We have determined that physicians and other healthcare providers would prefer that such a site is ethical, credible, insightful, unbranded and objective. We have further determined that such a site should be for physicians and healthcare professionals, and provide access to premium medical resources.

Unfortunately, conventional systems failed to meet these and other needs of physicians. Moreover, none of these conventional systems specifically provide, for example, a method or system assisting in the preparation of professional presentations, including images and speaker notes, for physicians and/or healthcare providers. Moreover, using conventional systems, it is not possible to, for example, store, combine, and/or divide selections of previously prepared segments directed to medical topics. In addition, it is not possible to store these selected slides, groupings of slides, and other information, in a folder for a user. Also, these conventional systems, for example, do not provide for a centralized collection of previously prepared slides, presentation notes, etc., for use by multiple users in remote locations, where such slides may optionally be incorporated into, e.g., commercially available presentation applications. There remains a need for such assistance for physicians and other healthcare practitioners in preparation of presentations.

### BRIEF SUMMARY OF THE INVENTION

The present invention alleviates the deficiencies of conventional techniques and systems described above. The invention enables information provision to physicians and other healthcare providers that is more targeted, more efficient and may be permission-based. The invention provides assistance to help physicians to obtain timely and appropriate information to help them practice better medicine. The system, according to one or more aspects of the invention, provides the right information in an appropriate format. It also provides for appropriate filtering of information. Another enduring value that the invention provides to physicians is an aggregation of resources in one place. The present invention provides a fairly easy way of distributing information targeted to certain physicians, and allowing those physicians to expose themselves more readily to new information. The present invention fosters the best practice of medicine, which creates simultaneous benefits for physicians, and patients.

The present invention may bring together a vast collection of resources available to physicians. The invention may provide a content library unmatched in its breadth. All told, these many resources may cover primary care and just about every specialty imaginable. An optional folder feature may allow physicians to document their visits with extensive bookmarking to track their progress (e.g., research links). Resources may include a lectures and presentations builder, allowing users to prepare custom slides for incorporation into, e.g., PowerPoint documents, and including, e.g., public speaking advice.

Accordingly, one or more embodiments of the invention provides healthcare professionals with the ability to preview and choose previously prepared visuals featuring medical content, e.g., images, concepts and statistics, along with up-to-date information on treatment and techniques. A user, optionally registered with the system, may log on; preview individual slides and/or slidekits; print the slides/slidekits; save them in the user's folder; and/or download a slide or slidekit, optionally for use in a commercial presentation application, e.g., PowerPoint™. Hence, a user may, if preferred, select a complete presentation, select individual slides, and/or search for a topic of interest. Further, the invention enables a registered and logged in user to keep bookmarks and folders of slides/slidekits on a central server instead of a local desktop, giving the user quick access to sections of one or more sites which are frequently used.

The invention provides a method, system, and computer program device for a slidekit presentation, for allowing a user to preview and/or select, at a user's local computer, one or more previously provided slides and slidekits available at another computer for incorporation into a presentation, where the user is a physician and/or a healthcare provider, the other computer optionally including a folder for the user for storing bookmarks and references to the slides and the slidekits selected by the user. The invention includes providing, on the other computer, slidekits, each of the slidekits having a slides related to a medical topic and an optional title reflecting the medical topic; each of the slides optionally including one or more of: a view image, a title, speaker notes, and a thumbnail image; and each of the slidekits being assigned to at least one category. The invention also includes displaying, responsive to a first user request, on the local computer communicating with the other computer, information representing the at least one category. Also included is displaying, responsive to a first user selection of the at least one category, a list of first information representing each of the slidekits assigned to the first user selection. The invention further includes displaying, responsive to a second user selection of one of the slidekits, second information representing at least a first one of the slides in the second user selection. Further included in the invention is displaying, responsive to a third user selection of at least one of the slides, third information representing the third user selection. Optionally included is sending, responsive to a fourth user selection, at least one of the selected slide and the selected slidekit, from the other computer to the local computer, wherein said sending optionally includes compressing and downloading the at least one of the selected slide and the selected slidekit. Optionally, the invention includes saving, responsive to a fifth user selection, a reference location to the at least one of the selected slide and the selected slidekit, to a folder assigned to the user, on the other computer. The invention optionally includes ensuring, responsive to a requested initiated by the user in at least one of the foregoing, that the user is currently logged in and registered to the other computer as at least one of a physician and healthcare provider. Further, the invention optionally includes saving, responsive to a second user request on the local computer, at least one bookmark into the user's folder maintained on the other computer. Also, optionally the invention includes displaying, responsive to a third user request to view the user's folder, information characterizing the user's folder including a list of folders and at least one of the bookmarks contained therein.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE SEVERAL VIEWS OF THE DRAWING(S)

The above-mentioned and other advantages and features of the present invention will be better understood from the following detailed description of the invention with reference to the accompanying drawings, in which:

FIG. 1 is a block diagram of a computer used for a prior art system for displaying a slide-show mode screen and an edit mode screen associated with conventional presentation systems.

FIG. 2 illustrates a prior art display screen that displays elements of a presentation to a presenter and to the audience in relation to the event.

FIG. 3 is a functional block diagram illustrating an example of a slidekit presentation preparation system, according to one or more embodiments of the present invention.

FIG. 4 is a block diagram illustrating an example of a folder for a user storing slides and slidekits for a presentation, according to one or more embodiments of the present invention.

FIG. 5 is a flow chart illustrating one or more embodiments of a method for preparing a slidekit presentation.

FIG. 6 is a flow chart illustrating one or more embodiments of a method for managing a user's folder.

FIG. 7 is a functional block diagram illustrating an example of authenticating a user's login and registration, and storing a bookmark into the user's folder.

FIG. 8 is a flow chart illustrating one or more embodiments of a method for managing a user's folder.

FIG. 9 is an exemplary user interface illustrating a slide image bank, listing categories of slide kits, for use in connection with preparing a slidekit presentation, in accordance with one or more embodiments of the present invention.

FIG. 10 is an exemplary user interface illustrating a slide image bank, listing slide kits in a category, for use in connection with preparing a slidekit presentation, in accordance with one or more embodiments of the present invention.

FIG. 11 is an exemplary user interface illustrating a slide image bank, listing slides in a slide kit, for use in connection with preparing a slidekit presentation, in accordance with one or more embodiments of the present invention.

FIG. 12 is an exemplary user interface illustrating a slide and associated information, in accordance with one or more embodiments of the present invention.

FIG. 13 is an exemplary user interface illustrating storing a slidekit in the slide image bank into the user's folder, in accordance with one or more embodiments of the present invention.

FIG. 14 is an exemplary user interface illustrating another embodiment of a slide image bank and user's folder, listing slidekits in a category, for use in connection with saving in the user's folder, in accordance with one or more embodiments of the present invention.

FIG. 15 is an exemplary user interface illustrating another embodiment of a slide image bank and user's folder, listing categories of slide kits, for use in connection with saving in the user's folder, in accordance with one or more embodiments of the present invention.

FIG. 16 is an exemplary user interface illustrating one embodiment of an initial view of the user's folder.

FIG. 17 is an exemplary user interface illustrating managing bookmarks, slides, and slidekits, in connection with the user's folder of FIG. 16.

FIG. 18 is an exemplary user interface illustrating editing folders, in connection with the user's folder of FIG. 16.

FIG. 19 is an exemplary user interface illustrating editing bookmarks, in connection with the user's folder of FIG. 16.

FIG. 20 is an exemplary user interface illustrating deleting bookmarks, slides and/or slidekits, in connection with the user's folder of FIG. 16.

FIG. 21 is an exemplary user interface illustrating adding folders, in connection with the user's folder of FIG. 16.

FIG. 22 is an exemplary user interface illustrating adding an external bookmark, in connection with the user's folder of FIG. 16.

FIG. 23 is an exemplary user interface illustrating an alternative view of adding an external bookmark.

FIG. 24 is a block diagram of a computer used for implementing one or more embodiments of the slidekit presentation preparation system, in accordance with a computer implemented embodiment of the present invention.

FIG. 25 illustrates a block diagram of the internal hardware of the computer of FIG. 24.

FIG. 26 illustrates a block diagram of an alternative computer of a type suitable for carrying out the present invention.

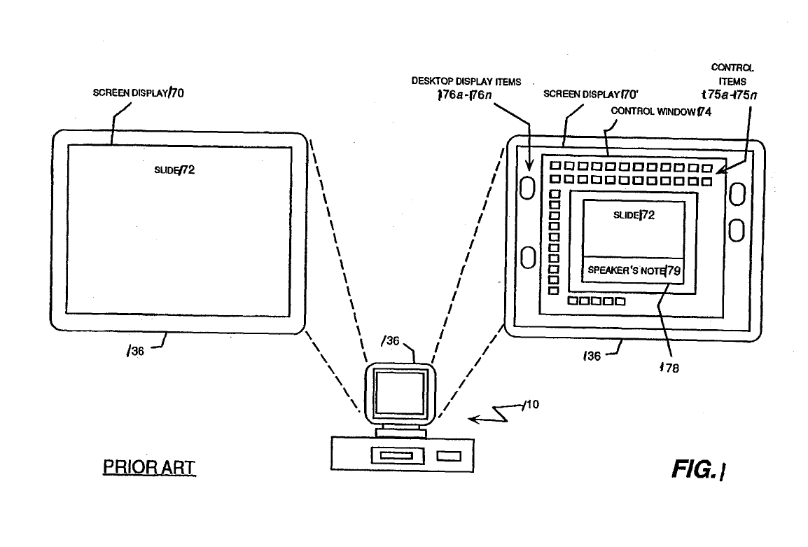

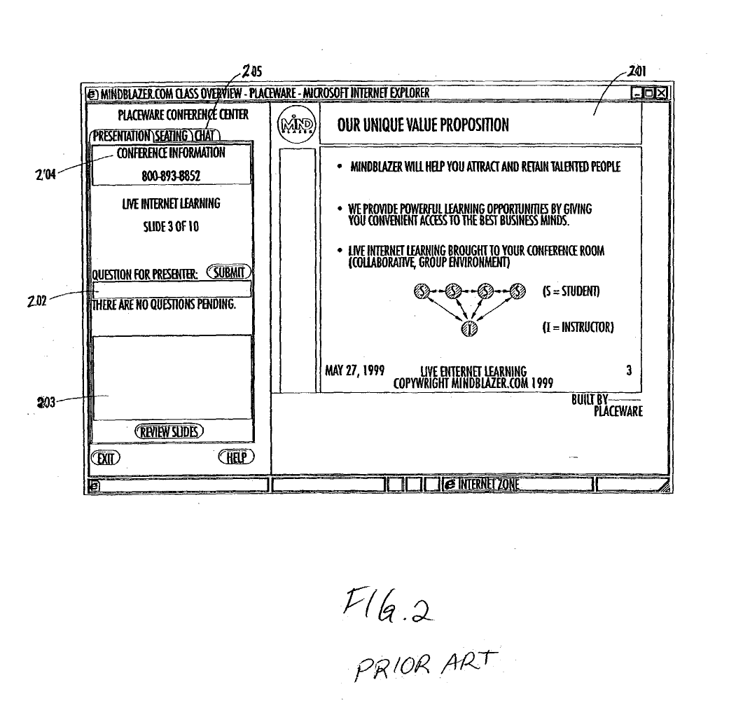

### DETAILED DESCRIPTION OF THE INVENTION

The following detailed description includes many specific details. The inclusion of such details is for the purpose of illustration only and should not be understood to limit the invention. Throughout this discussion, similar elements are referred to by similar numbers in the various figures for ease of reference. In addition, features in one embodiment may be combined with features in other embodiments of the invention.

The present invention provides a slidekit presentation preparation system and method, allowing users to build, e.g., lectures and presentations. Users may prepare custom slides and slidekits for incorporation into, e.g., PowerPoint documents, and including, e.g., public speaking advice. A slidekit comprises, for example, a unified collection of one or more slides, directed to a particular medical topic, and have preferably been professionally prepared. The slides and slidekits provide a sophisticated library of previously-prepared lectures ready for use by users. The slides and slidekits are optionally provided from a central source, e.g., a host computer. Optionally, selected slides and/or slidekits may be compressed, downloaded, and/or printed at a user's local computer from the central source. The slides and slidekits include information for enhancing the user's preparation and delivery or a presentation. For example, each slide includes one or more of: a title, a summary, a thumbnail image, a full image, and/or lecture notes; each slidekit includes a title and a summary, plus the slides.

The present invention may include an optional folder feature to allow physicians to document their visits with extensive bookmarking to track their progress (e.g., research links). Optionally, the user's folder is provided on the host system, and accessed by the user from the user's local computer.

Accordingly, one or more embodiments of the invention provides healthcare professionals with the ability to preview and choose previously prepared visuals, appropriate for a presentation, featuring medical content, e.g., images, concepts and statistics, along with up-to-date information on treatment and techniques. A user, optionally registered with the system, may log on; preview individual slides and/or slidekits; print the slides/slidekits; save them in the user's folder; and/or download a slide or slidekit, optionally for use in a commercial or standard presentation application, e.g., PowerPoint™. A user may, if preferred, selected a complete presentation, select individual slides, and/or search for a topic of interest. Further, the invention enables in one embodiment a registered and logged in user to keep bookmarks and folders of slides/slidekits on a central server instead of a local desktop, giving the user quick access to sections of one or more sites that are frequently used.

The present invention provides a system and method for bringing together the vast array of resources available to physicians. Hence, according to one or more embodiments, the invention may provide a content library unmatched in its breadth. Further, the invention may provide a lectures and presentations builder, allowing users to prepare custom slides for incorporation into, e.g., PowerPoint documents, and including, e.g., public speaking advice.

One or more aspects of the invention optionally provides access to healthcare and medical resources. The term “resources” used herein is intended to encompass, e.g., information, services, content, applications, and anything else available electronically. According to one or more embodiments of the present invention, medical information resources may include, for example, one or more of reference books and/or databases; several outstanding and/or definitive medical information resources may be accessed electronically, including:

National Library of Medicine databases: MEDLINE, AIDSLINE, Bioethics Line, CANCERLIT,

Harrison's Principles of Medicine,

Dorland's Medical Dictionary,

Physicians' Desk Reference (PDR) and PDR Drug Interaction Database,

Mosby's GenRx, Patient GenRx and Drug Master Plus (drug interaction database),

Merck Manual Online,

Merck Manual Home Edition,

Cecil Textbook of Medicine, and/or

Best Practice of Medicine by PraxisMD

According to one or more embodiments of the present invention, resources may include news, such as available from headlines, abstracts, full journal articles from medical journals, e.g., JAMA, NEJM, Lancet, Annals of Internal Medicine, and BMJ. Other news resources may be provided from a newswire service of breaking news stories about medicine, e.g., those that could impact a physician's practice. Resources may also include medial, specialty and/or consumer news. Such articles cover the business of healthcare, consumer medical news, and other health-related news items, and may be obtained from professional and/or lay press resources, e.g., Reuters, FaxWatch, and NewsRX. Optionally, the news directed to the user may be restricted to items of interest to the user, such as matching user registration information.

Another example of medical information resources includes professional development resources and tools, e.g., continuing medical education (CME) information, online CME, a medical meeting calendar with a list of at least major professional conferences, information and/or review modules regarding board review for various therapeutic areas for Board certification and re-certification, links to professional societies, links to government web sites, links to medical schools, and/or access to clinical trials information.

Another type of resource relates to patients, e.g., patient education materials such as leaflets, optionally editable/customizable; patient sheets, e.g., printable articles intended for patients to help them better understand their disease and treatment; patient health news, e.g., an archive of health-related news articles in the popular lay press (off line, online, and/or in print); clinical trial information, e.g., a searchable database of clinical trials such as sponsored by NIH and/or industry; links to support groups serving patients, such as in various disease states; and/or a best health guide, having patient education materials and consumer medical news, that may be customizable, printable, and/or e-mailable.

Yet another type of resource relates to practice technology, including for example, health technology news, including news articles and features about technology issues affecting the practice of medicine; evaluations of health technology vendors, e.g., review/comparison of the latest office technology for physician practices, such as billing and scheduling systems and electronic medical records management; interactive technology services, e.g., e-mail questions and answers, as well as FAQs, from a healthcare technology professor; a technology glossary, e.g., a searchable list of technology terms; and/or practice technology assessment services, to assess a level of technological sophistication in a doctor's practice.

Optionally, an electronic folder may be provided for each user, in which the user may organize and store articles, patient materials, and/or links for their convenience and future reference.

Other types of resources include hospital offerings that address the needs of hospital-based audiences (residents, house staff, hospital physicians). Such resources may include, e.g., medical calculators/information, including medical and non-medical information, calculators and content from various sources that are targeted to the needs of residents and medical students; an organizer for medical contents and tables on a PDA to assist users while they work with quick, problem-based solutions to medical questions/clinical issues. Resources intended for hospital physicians include, e.g., reference texts, e.g., culled from core site content as most appropriate for hospital physicians, PDA-downloadable content culled from the core site and customizable by the user; and/or a programmable medical calculator for important clinical calculations.

Other resources include, for example, clinical support tools that provide evidence based therapies and treatments, dosage recommendations, based on patient-specific data; an online ICD-9 Code reference for patient education; PDA software; a web-enabled version of well-respected texts, e.g., Brunwald's Atlas of Internal Medicine, including disease images, charts, and tables, which are optionally downloadable for incorporation into, e.g., medical lectures; and a meeting reporter having news, analysis, posters, and lecture summaries from major medical meetings.

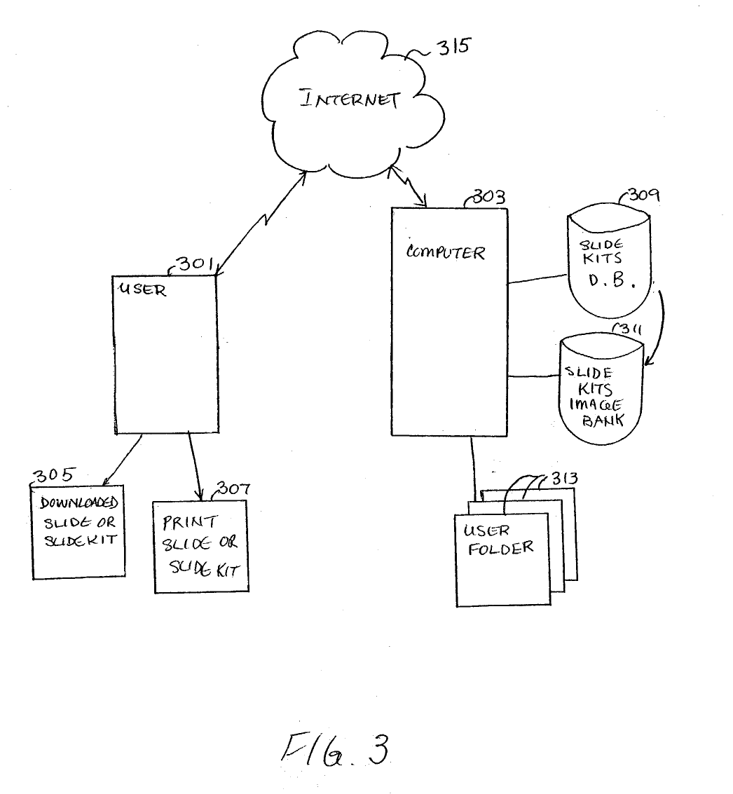

Reference is now made to FIG. 3, a functional block diagram illustrating an example of a slidekit presentation preparation system, according to one or more embodiments of the present invention. In this example, the slide kit presentation preparation is performed in connection with a user 301 on, e.g., a remote computer accessing, for example, a host computer, central computer or other computer in a distributed system 303. The computer 30 includes a slidekits database 309 storing information regarding each slidekit, e.g., category (or categories), title, brief descriptions, list of slides in the slidekit, etc.; and a slidekits image bank 311 storing inforation regarding each slide, e.g., title, summary description, associate lecture notes, full image, thumbnail image, etc. Optionally, the computer 303 includes a user folder 313 for each registered user. The user 301 may access the slidekits via the computer 303, and may optionally store one or more slides and/or slidekits into the user's folder. Optionally, the user may cause a slide or slidekit to be printed 307 or otherwise reproduced at the user's remote computer. Optionally, the user may cause a slide or slidekit to be downloaded 305 to the remote computer. The slide or slidekit to be downloaded and/or printed may be compressed, such as being zipped, prior to being transferred from the computer 303 to the user's 301 remote computer. The user may optionally store bookmarks, for a wide variety of resources, in the user's folder 313. The resources may be local to the computer 303, the user's computer, or external resources such as may be available via the Internet 315.

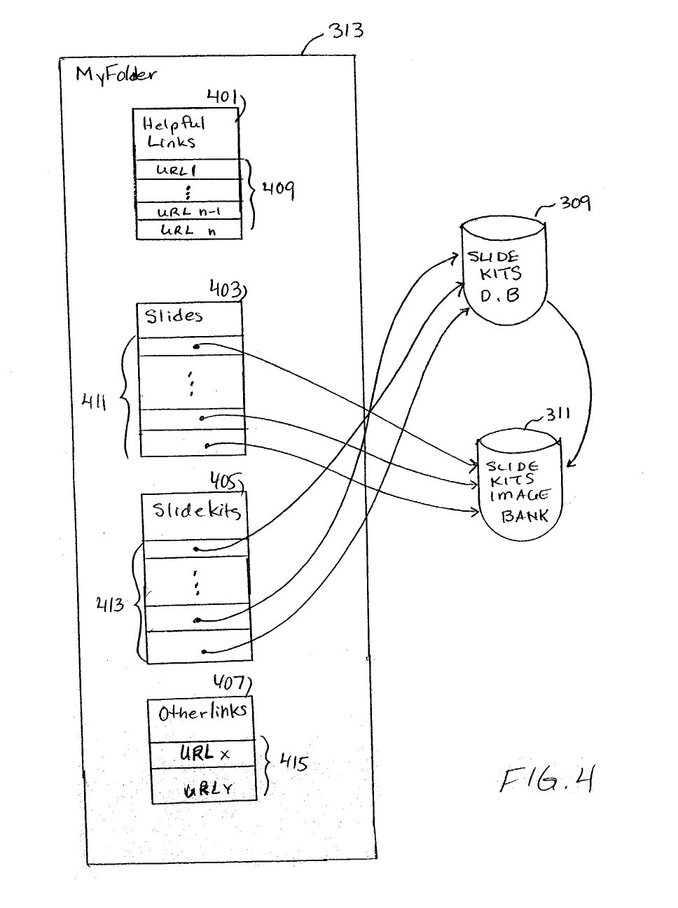

Reference is made to FIG. 4, illustrating an example of a user's folder 313 used for storing slides, slidekits, and bookmarks. The user's folder 313 may include other folders and/or bookmarks. The folders and/or bookmarks may be created by the user and may be included in the user's folder 313. One of the folders may be of slides and/or slidekits. In the present example, the user's folder 313 titled “MyFolder” includes a first folder of bookmarks 401 titled “Helpful Links”, and a second folder of bookmarks 407 titled “Other Links”. The folders of bookmarks contain uniform resource locators (URLs) 409, 415 for sites they are bookmarking. The bookmarked sites may be internal or external. The user's folder also includes a slides folder 403, containing, e.g., slides or slide locations 411; and a slidekits folder 405, containing, e.g., slidekits or slidekit locations 413. In the illustrated example, the slidekits folder 405 and the slides folder 403 include references to the slidekits database 309 and the slidekits image bank 311, respectively; storing references (e.g., pointers, links, etc.) advantageously requires less storage space than storing the actual slides/slidekits in the user's folder 313.

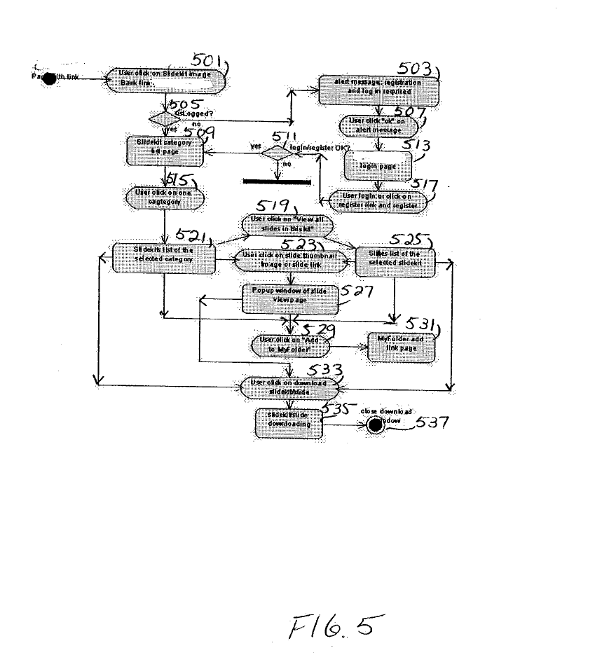

FIG. 5 illustrates one potential method for preparing a slidekit presentation. Here, at block 501, the user clicks on the slidekit image bank link on the user interface. At block 505, the system optionally checks whether the user is logged in. If not logged in, then at block 503, the system provides the user with an alert message that registration and login are required; the user may click on the alert message at block 507 and proceed to the login page at block 513. If the user then logs in or registers, block 517, the system checks whether the login and registration is accepted at block 511. Once successfully logged in, the system provides a list page of the slidekit categories, block 509. At block 515, when the user clicks on one of the categories, the system provides a list of the slidekits corresponding to the selected category. From the slidekits list, the user's options are to “view all slides in this kit”, click on a slide thumbnail image or slide link, click on “download slidekit/slide”, and/or click on “add to MyFolder”. If the user selects to “View all slides in this kit”, block 519, the system provides a list of the slides in the selected slidekit, block 525. If the user selects a slide thumbnail or slide link, block 523, the system provides a popup window of the slide view page, block 527. If the user wishes to download the slidekit/slide, block 533, the system commences with downloading the slidekit/slide, block 535. Of course, the above logical blocks may be performed in any order, and not all blocks need be performed in accordance with the present invention.

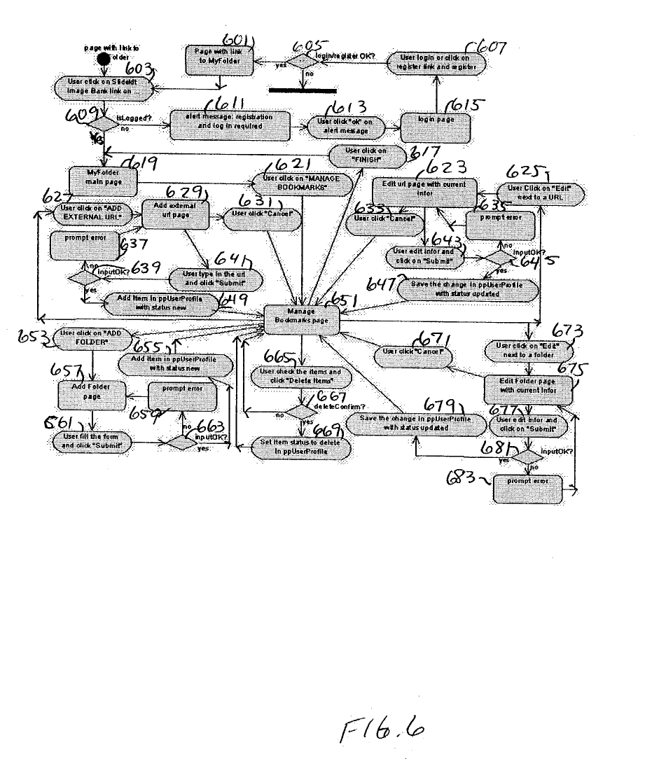

Reference is now made to FIG. 6, illustrating an example process implementing one or more embodiments of managing a user's folder. A display, computer page or web page is displayed with a link to the user's folder, e.g., block 601. Such page may be displayed, e.g., after the user accesses the login page, block 615, if the user is logged in and registered, block 607, and the login and registration attempt is successful, block 605. At block 603, the user has clicked on the Slidekit Image Bank link (in this example, the slidekits main page). If the user is not logged in, block 609, an alert message indication that registration and log in are required is displayed, block 611, and the user may click on the alert message, block 613, and may then proceed to the login flow, block 615. If the user is logged in, then at block 619, the system displayed the main page for the folder. If the user selects to manage bookmarks, block 621, the “manage bookmarks” page is displayed, block 651. The “manage bookmarks”, page lists the current bookmarks (internal and/or external URLS) and slides/slide kits, in connection with their associated folders. From the “manage bookmarks” page, the user may “finish” block 617 and return to the main page; select and edit a URL block 625; select and edit a folder block 673; check one or more items and select “delete” block 665; select to “add” a folder block 653; or select to “add” an external URL block 627, all described further below.

After choosing to select and edit a URL block 625, a page allowing the user to add the relevant information is provided, block 623, and the user may edit and submit the information, block 643. If the input is erroneous, block 645, the user is prompted for corrections block 635. Alternatively, the changes are saved in the user's profile, the status is updated, block 647, and the user is returned to the manage bookmarks page, block 651. After choosing to select and edit a folder block 673, the system displays the folder page with the current information block 675. The user may “cancel” block 671 and return to the “manage bookmarks” page. Otherwise, the user edits the information and clicks on “submit”, block 677. If the information is erroneous, block 681, the user is prompted for the error, block 683, and returned to the Edit Folder page, block 675. Otherwise, the changes are saved in the User Profile and the status is updated, block 679, and the user is returned to the Manage Bookmarks page block 651. After checking one or more items and selecting “delete” block 665, the system confirms the delete, block 667. If the delete request is not confirmed, the user returns to the Manage Bookmarks page, block 651. Otherwise, the checked items are set to a delete status in the user's profile, block 669, and the user returns to the Manage Bookmarks page, block 651. After choosing to “add” a folder block 653, the “add folder” page is displayed, block 657, and the user completes and submits the form, block 661. If the input is erroneous, block 663, the user is prompted with the error block 659; otherwise, the system adds the new item to the user's profile block 655. After choosing to “add” an external URL block 627, the user is prompted to add the external URL, block 629. The user may “cancel” block 631 and return to the “manage Bookmarks” page block 651. Alternative, the user may indicate and submit the URL, block 641. If the input is erroneous, block 639, the user is prompted with the error, block 637; otherwise, the system adds the item to the user's profile, block 649, and returns to the Manage Bookmarks page, block 651. Of course, the logical blocks described above may be performed in different orders and/or different combinations.

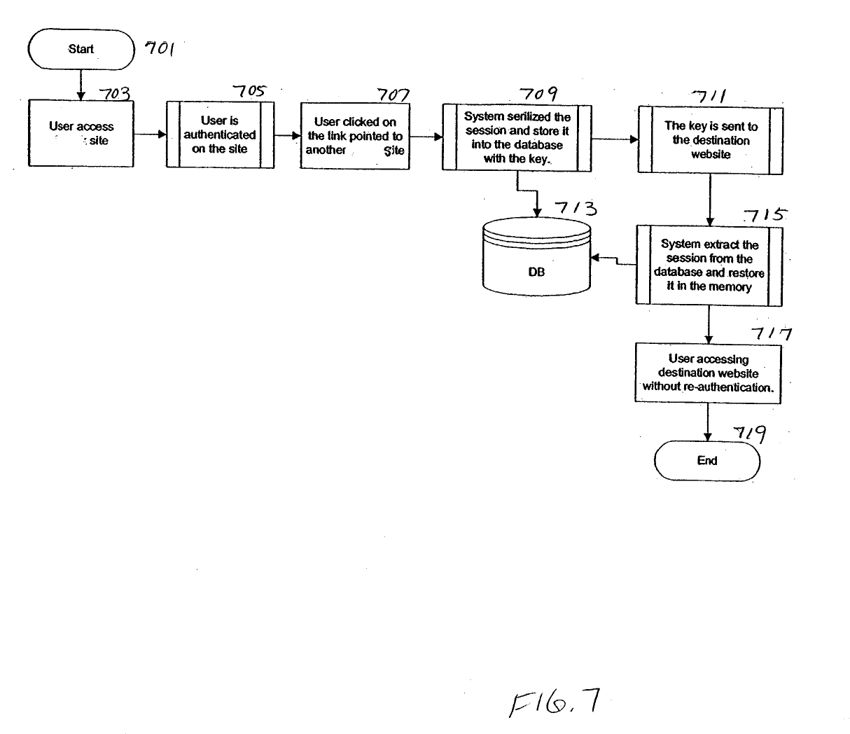

FIG. 7 is a functional block diagram illustrating an example of authenticating a user's login and registration, and storing a bookmark for an external site into the user's folder. This is particularly useful when the user attempts to access an external site requiring authentication. Starting at block 701, the user accesses the system site, block 703. At block 705, the user is authenticated on the site; at block 707, the user has selected or clicked on a link pointing to a destination site. At block 709, the system has serialized the session on the system site, and stored it into a database, together with a key. At block 711, the key is sent to the destination web site. At block 715, the system extracts the stored session from the database and restored it, so that the user is returned to the session on the system site. At block 717, the user may access the destination website without requiring authentication. At block 719, the system ends. Other orders and/or combinations of the logical blocks may be performed.

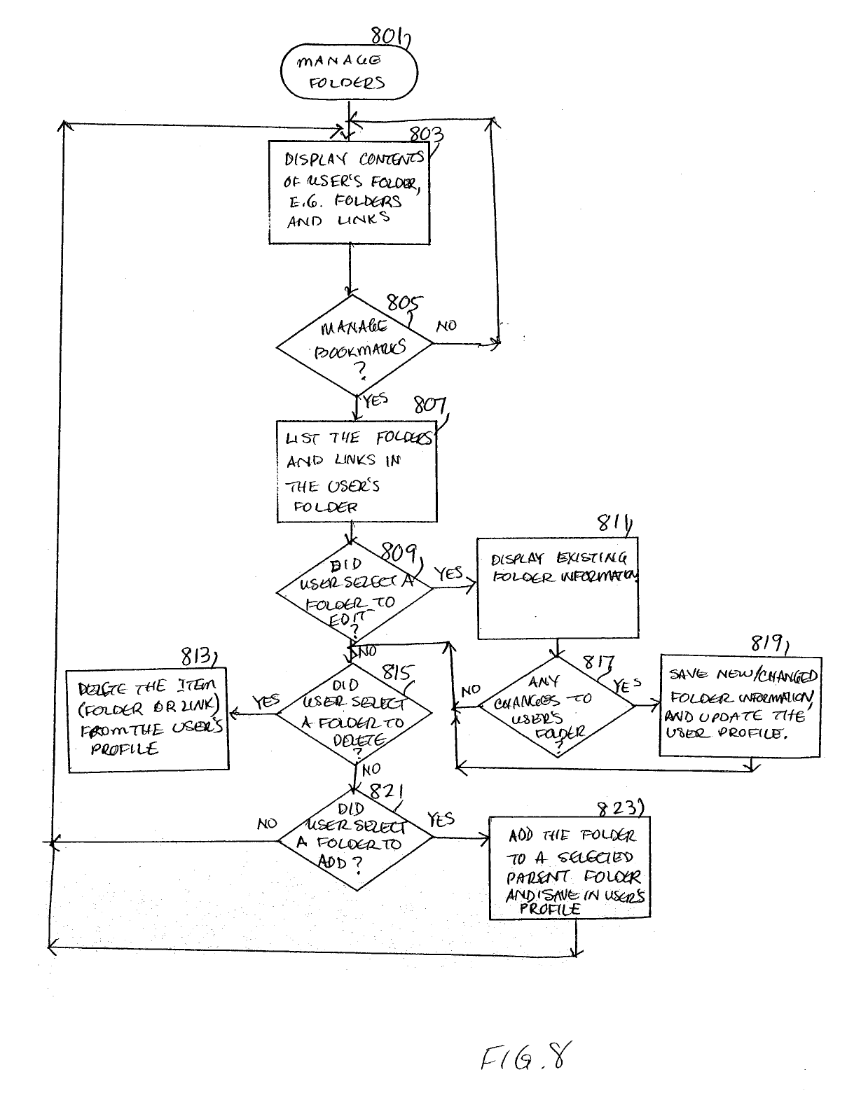

FIG. 8 is a flow chart illustrating one or more embodiments of a method for managing a user's folder, 801. At block 803, the system displays the contents of the user's folder, for example, other folders such as containing slides and/or slidekits, and links. At block 805, the system interacts with the user to determine whether the user wishes to manage their bookmarks. If not, the system loops back, block 803. Otherwise, the system lists the folders and links in the user's folder, block 807. If the user selects a folder to edit, block 809, the system displays the existing folder information, block 811; checks for any changes to the user's folder, block 817, and for any changes, saves the new/changed folder information, and updates the user profile, block 819. If not, and if the user selected a folder to delete, block 815, the system deletes the item (folder or link) from the user's profile at block 813, and loops back, block 803. Otherwise, if the user selected a folder to add, block 821, then at block 823 the system adds the folder to a selected parent folder and saves the information in the user's profile. Other orders and/or combinations of logical blocks may be performed.

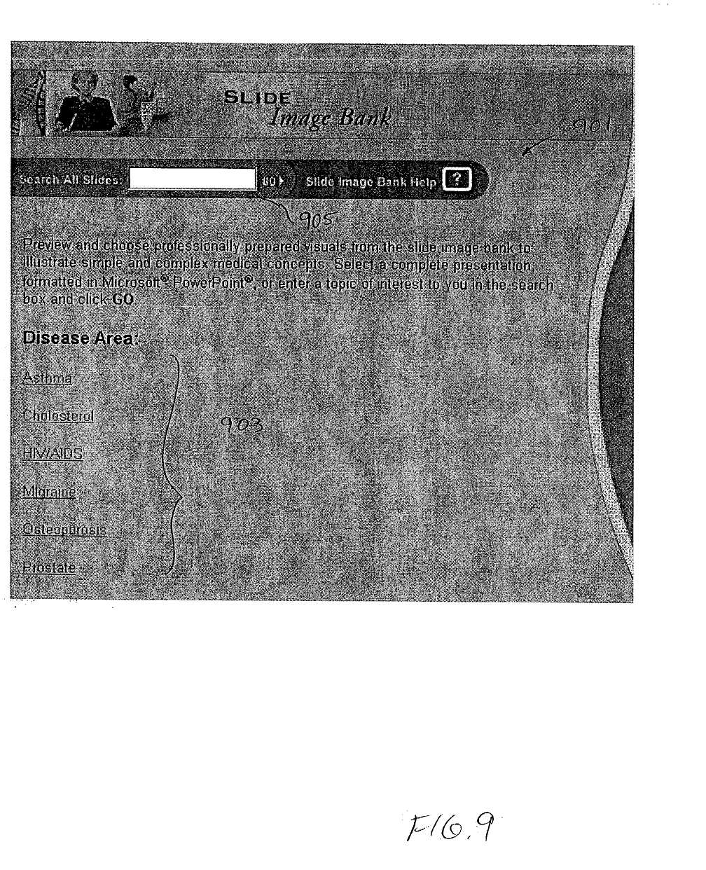

FIG. 9 is an exemplary user interface 901 illustrating a slide image bank, listing categories of slide kits, for use in connection with preparing a slidekit presentation. The illustrated example is useful as a main page. The various categories to which slidekits are assigned are listed 903. Optionally, a search 905 is provided, so the user may search the slides, e.g., by keyword and/or text descriptions.

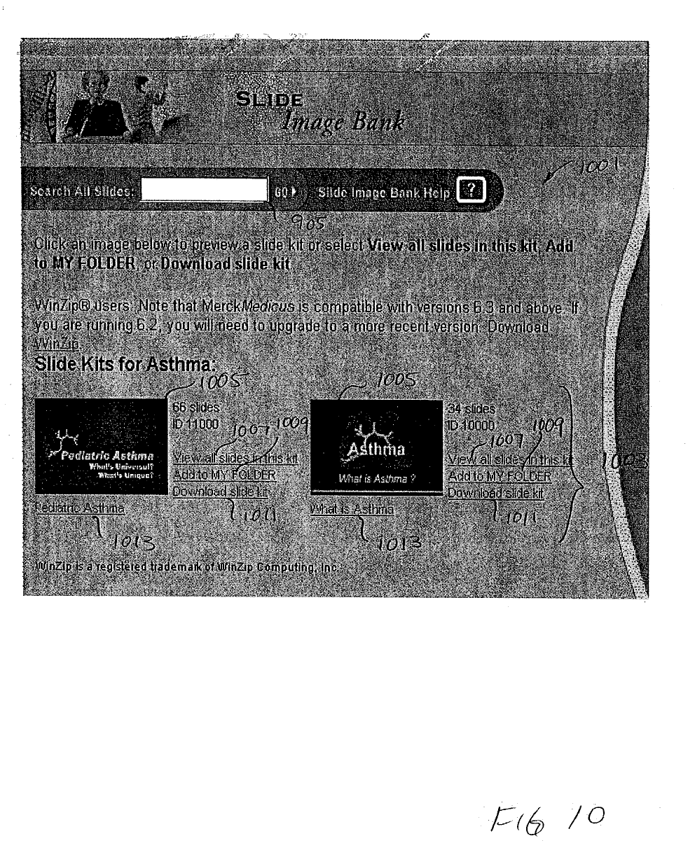

FIG. 10 is an exemplary user interface 1001 illustrating a slide image bank, listing slide kits in a category. Here, the optional search 905 is included. A category has been selected, and the slidekits 1003 assigned to that category are listed. The information listed for each slidekit may include, in this example, a thumbnail for, e.g., the first slide 1005; a title for the slidekit 1007; a brief description of the slidekit, 1013. The user is provided with buttons to add the slidekit to the user's folder 1009, and/or to download the slidekit 1011. A slidekit that is downloaded to a user's computer may easily be included in a presentation, just as any other file, in commercial presentation applications, e.g., PowerPoint™.

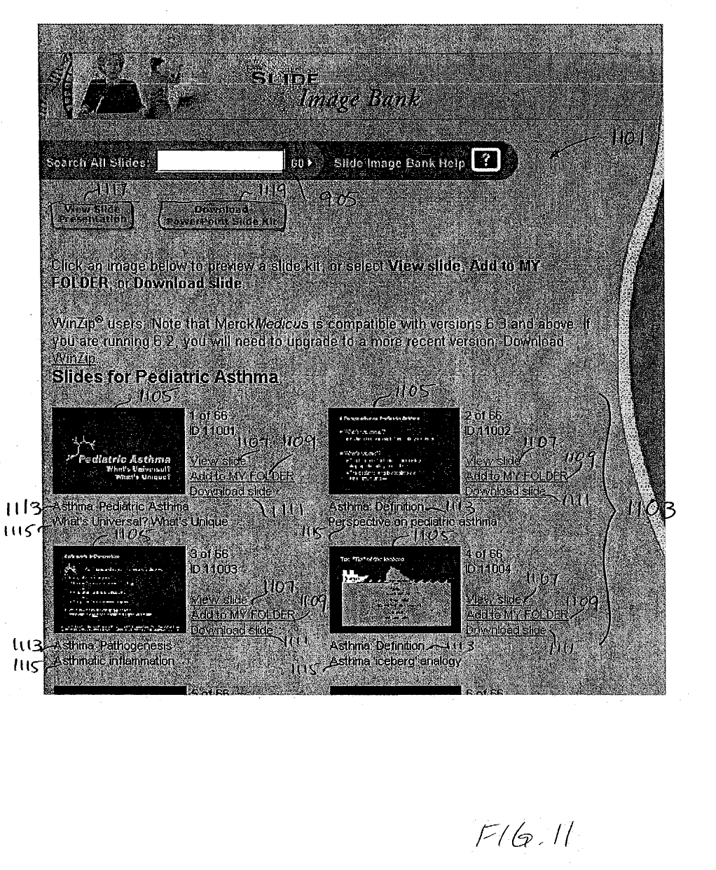

FIG. 11 is an exemplary user interface 1101 illustrating a slide image bank, listing slides in a slide kit, for use in connection with preparing a slidekit presentation. The optional search 905 is included. Here, the user has selected a particular slidekit. The system displays information on each slide 1103. Here, the information for each slide includes a thumbnail 1101, a title 1113, and a brief description 1115. The user is provided with buttons to view the slide 1107, add the slide to their folder 1109, download the slide 1111, view the entire slide presentation for the slidekit 1117, and/or download a slidekit 1119.

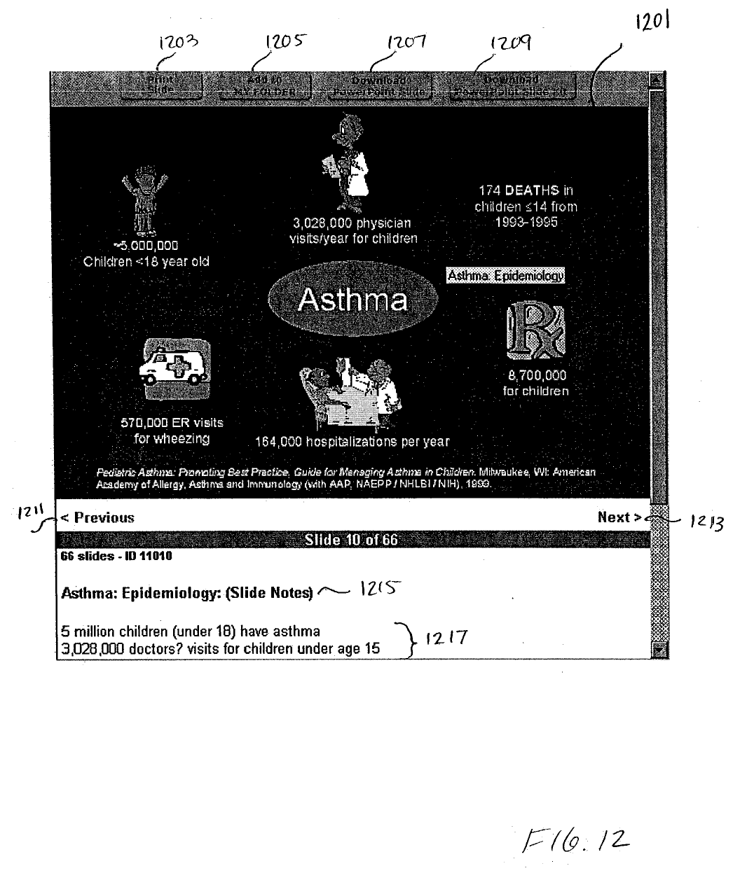

FIG. 12 is an exemplary user interface 1201 illustrating a slide and associated information. The full image 1201 is displayed, together with the title 1215 and lecture notes 1217. The system optionally provides buttons to print the slide at the user's printer 1203, add the slide to the user's folder 1205, download the slide 1207, download the slidekit 1209, and/or go to the next/previous slide 1211, 1213.

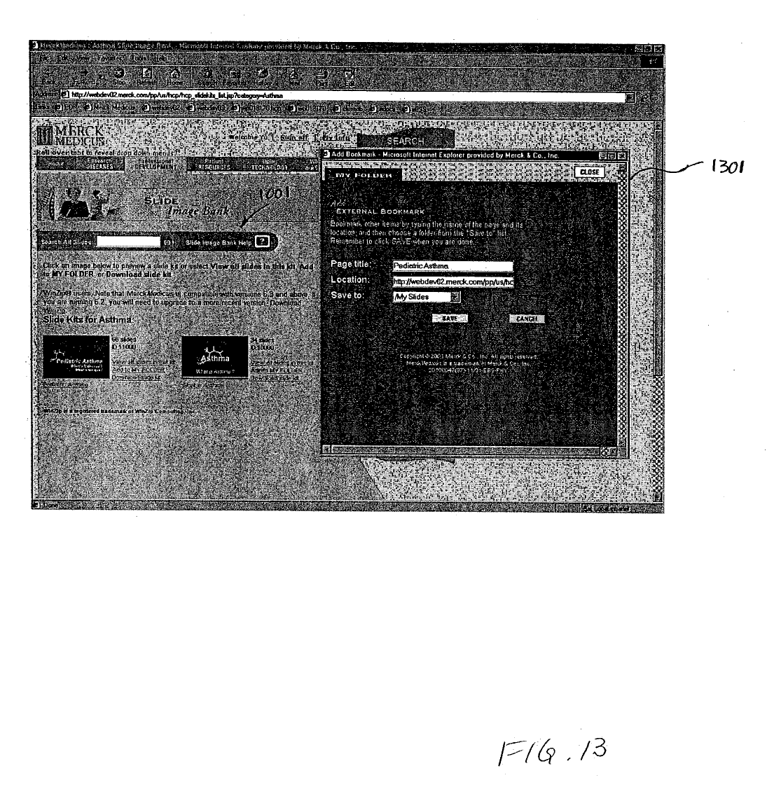

FIG. 13 is an exemplary user interface illustrating storing a slidekit in the slide image bank into the user's folder. Here, the display lists several slidekits 1001. The user's folder 1301 is provided in a popup display. A menu 1313 is provided to add the slidekit to the user's folder. Here, the menu includes a page title 1303, location 1305, and folder 1307 to which the slidekit is to be saved. The user may edit the information. A button is provided to save and/or cancel 1309, 1311 the information.

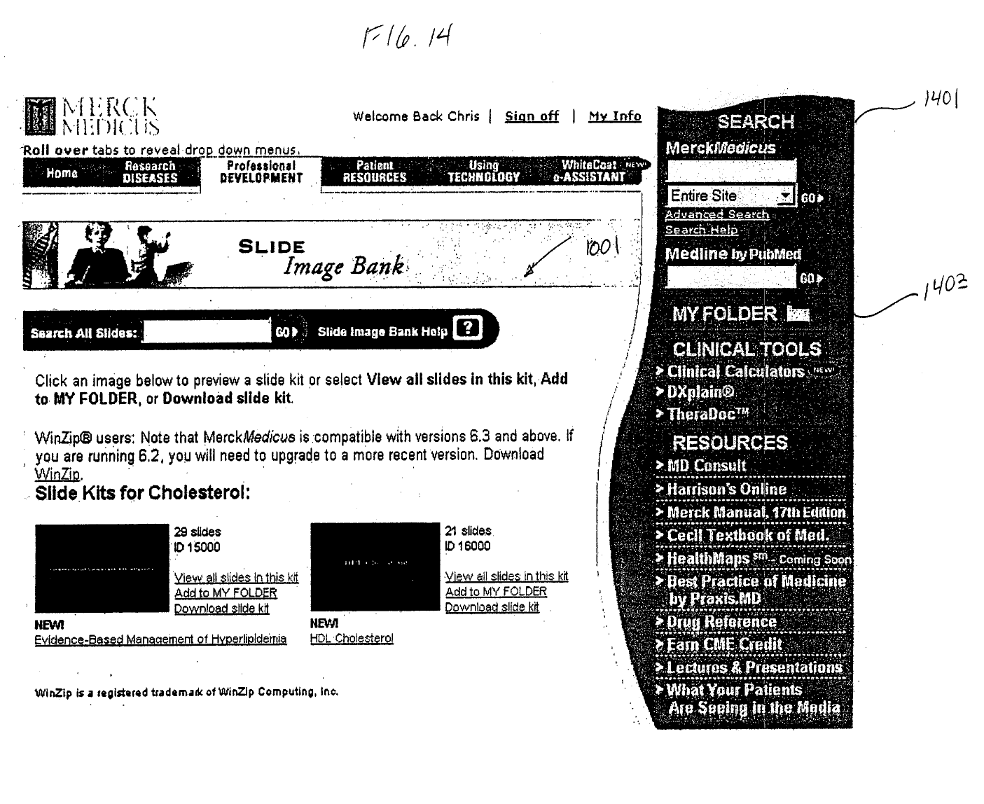

FIG. 14 is an alternative example of a user interface for a slide image bank and user's folder, listing slidekits in a category, for use in connection with saving in the user's folder. Here, the folder 1403 is provided in a toolbar 1401 on the slidekits display 1001 listing slidekits for a category, rather than in a popup window.

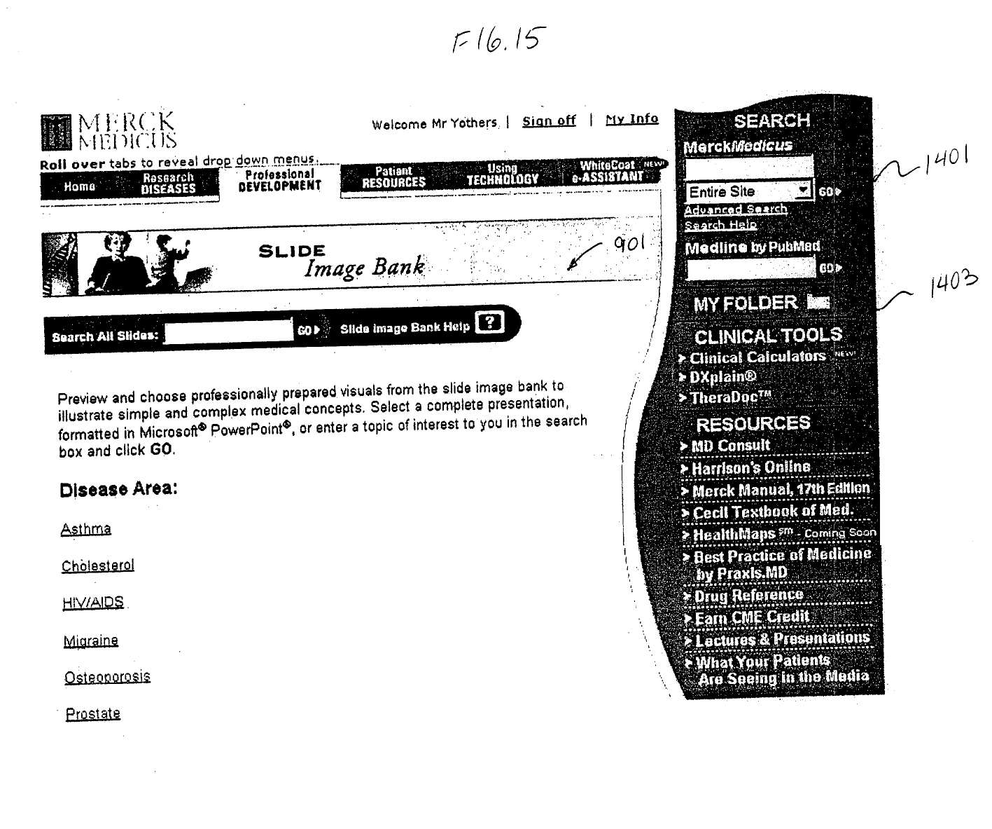

FIG. 15 is an alternative example of a user interface for a slide image bank and user's folder, listing categories of slide kits, for use in connection with saving in the user's folder. Here, the folder 1403 is provided in a toolbar 1401 on the slidekit categories display 901 listing slidekit categories, rather than in a popup window.

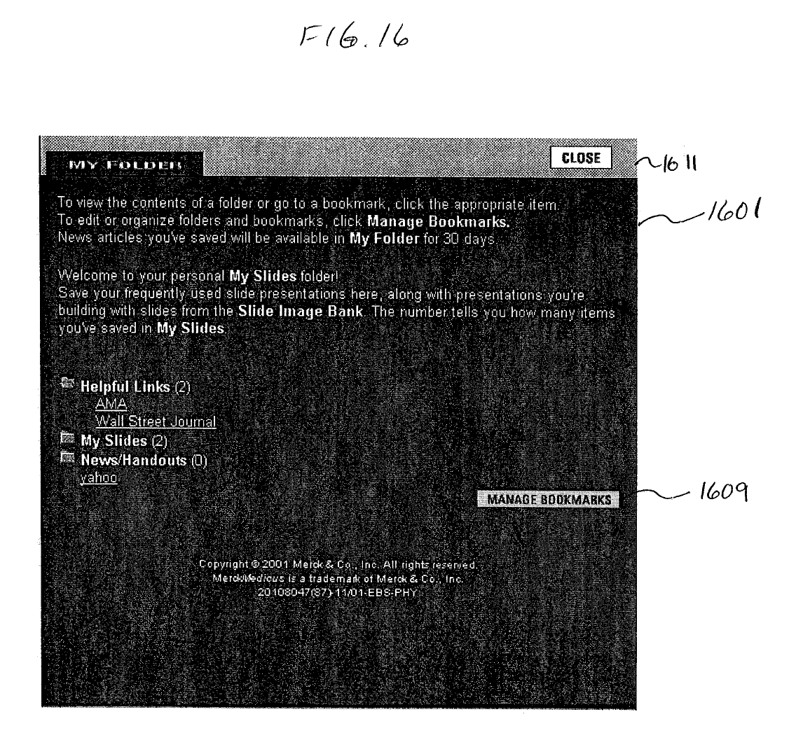

Reference is now made to FIG. 16, illustrating one example of an initial view (or main page) of the user's folder 1601. The main page 1601 includes a list of folders 1603, 1605, 1607. One of the folders is a slides folder 1605. Other folders, in this example titled by the user as “Helpful Links” 1603 and “News/Handouts” 1607, include links designated by the user. To view the contents of a folder or go to a bookmark, the user clicks the appropriate item. To edit or organize folders or bookmarks, the user selects the “Manage Bookmarks” button 1609. The number of items in each folder optionally is indicated. Optionally, the user may select the close button 1611 to close this page.

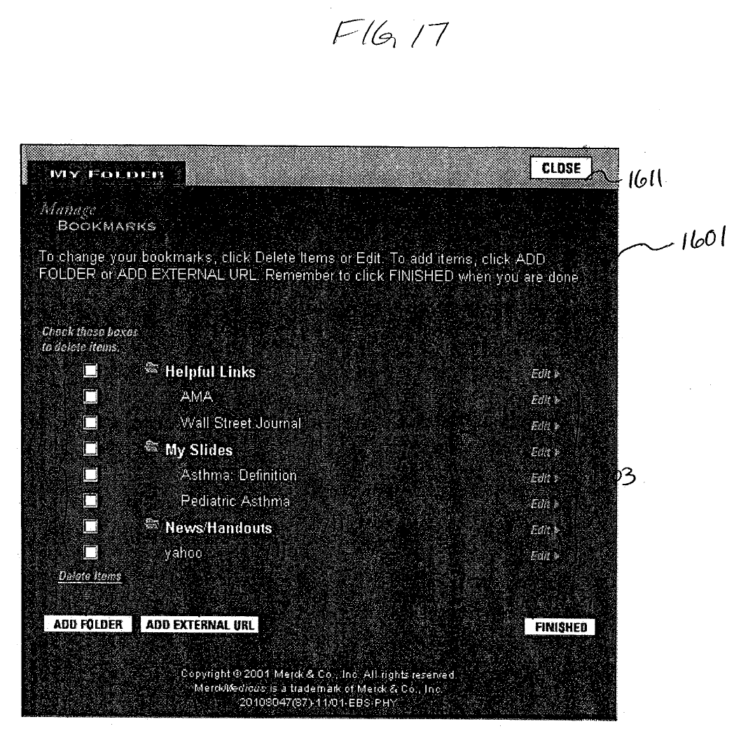

Reference is now made to FIG. 17, illustrating an example of a user interface for managing bookmarks, slides, and slidekits, in connection with the user's folder. The system provides a listing of the folders 1711 and items in each folder 1713. Optionally, the user may select checkboxes 1701 in order to delete items. Optionally, the user may select to edit 1703 an item. Optionally, the user may add a folder or item in a folder 1705, or may add an external URL 1707. The user may select the “finished” button 1709 to terminate.

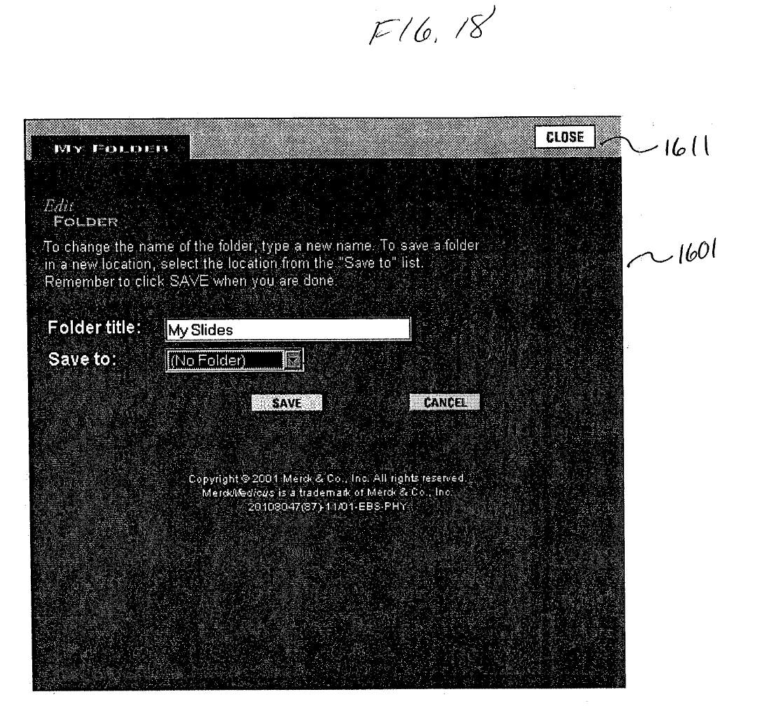

Reference is now made to FIG. 18, providing an example of a user interface 1601 illustrating editing folders, in the user's folder. The user has previously selected a folder to edit. To change the name of a folder, the user enters the new title 1801. To change the location, the user enters the new location of the folder 1803.

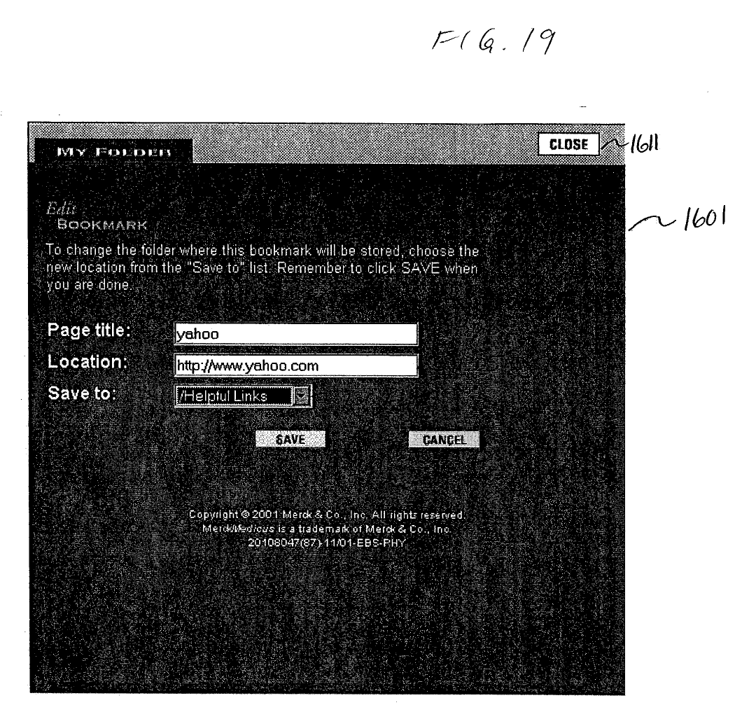

Reference is now made to FIG. 19, providing an example of a user interface 1601 illustrating editing of bookmarks in the user's folder. The user has previously selected a folder to edit. To change the folder where a bookmark is stored, the user enters the new location 1305, and selects the save button 1309.

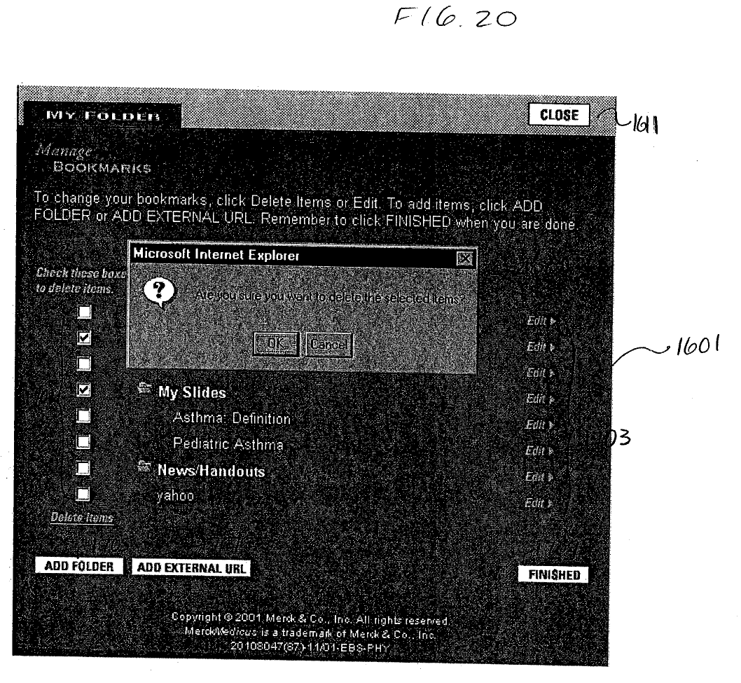

Reference is now made to FIG. 20, providing an example of a user interface 1601 illustrating deleting of bookmarks, slides and/or slidekits in the user's folder. Here, the user has previously selected check boxes 1701 for various folders or bookmarks, and has selected to delete the checked items. The system displays a confirmation popup window 2001 to ensure that the user wants to delete the selected items. If the selected items are to be deleted, they are marked for deletion from the user's profile; the items remain in their original location, e.g., a slide is not deleted from the slidekits image bank.

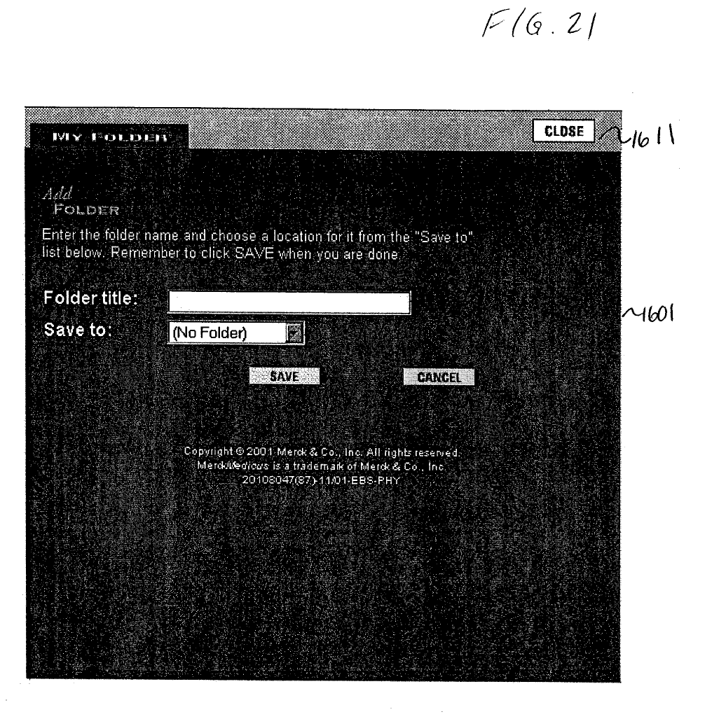

Reference is made to FIG. 21, illustrating an example user interface 1601 for adding folders, into the user's folder. To add a folder, the user provides a folder title 1801, and indicates an existing folder 1803 to which the newly added folder is to be saved.

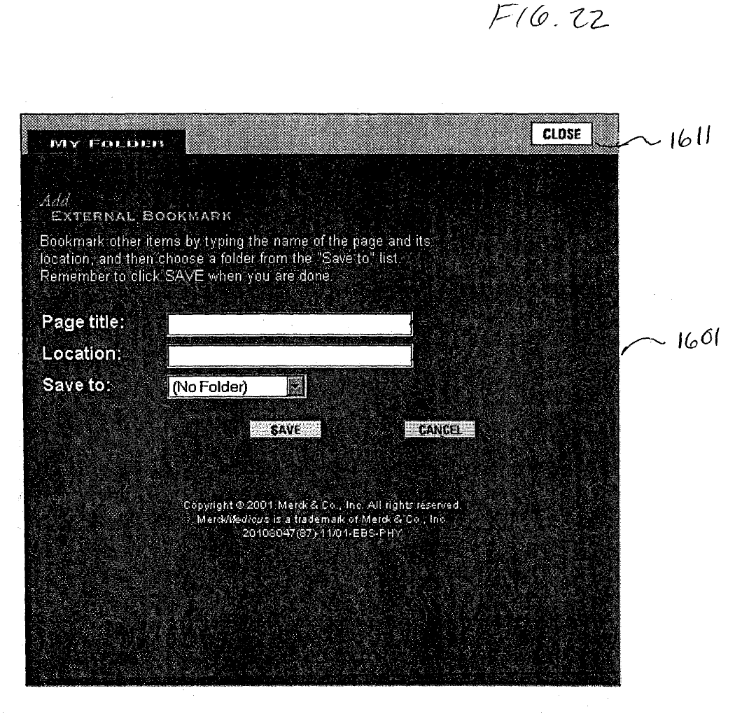

Reference is now made to FIG. 22, illustrating an example user interface 1601 for adding an external bookmark to the user's folder. The user may bookmark other items by assigning a page title 1303, indicating the page's location 1305, and choosing a folder 1307 in which the bookmark is to be saved. The save button 1309 may be selected when the user is ready to save the bookmark.

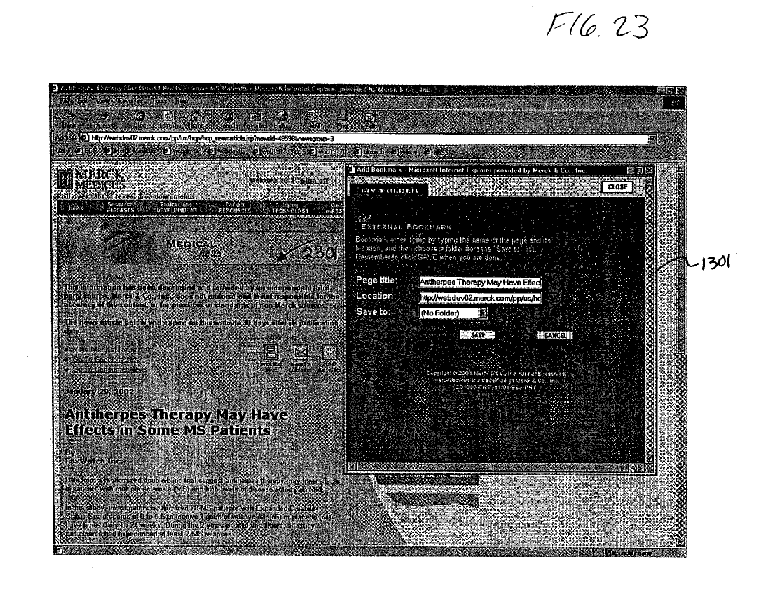

FIG. 23 is an alternative example user interface for adding an external bookmark. In this example, the user interface is provided in a popup window 1301. The page to be added as a bookmark is a page listing a variety of “medical news” 2301. The page is “external”, that is, the URL is not internal to the system, e.g., not a slidekit, not system-provided bookmarks.

It should be understood that the invention is described in connection with logical groupings of functions or resources. One or more of these logical groupings may be omitted from one or more embodiments, and still remain within the scope of the present invention. Likewise, functions may be grouped differently, combined, or augmented without parting from the scope of the invention. Similarly the present description may describe various databases or collections of data and information. One or more groupings of the data or information may be omitted, distributed, combined, or augmented, or provided locally and/or remotely without departing from the scope of the invention.

The user may be a physician or other healthcare professional or student of in the medical field. Some of these users may be licensed for a specific practice, and the licensure may be verifiable. The system may provide the user with expanded online access to high quality healthcare resources. The system may respond to the shifting needs of healthcare professionals, who are constrained to find practical ways to access information and services relevant to their practices, despite their business schedules and geographic constraints. Further, the present invention is intended to provide seamless access to such information.

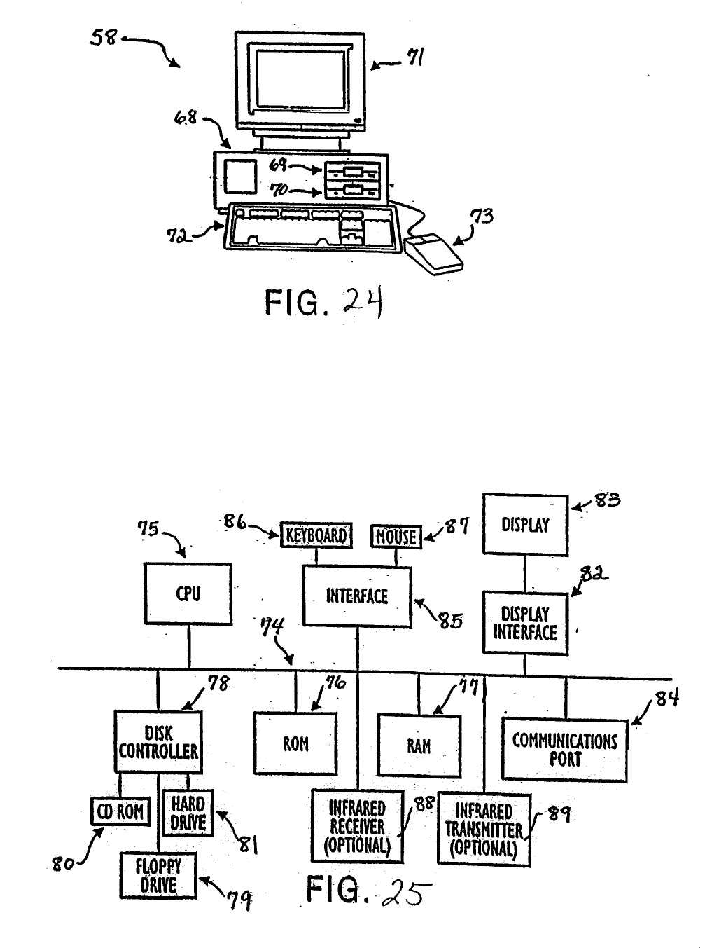

FIG. 24 is an illustration of a computer 58 used for implementing the computer processing in accordance with a computer-implemented embodiment of the present invention. The procedures described above may be presented in terms of program procedures executed on, for example, a computer or network of computers.

Viewed externally in FIG. 24, computer 58 has a central processing unit (CPU) 68 having disk drives 69, 70. Disk drives 69, 70 are merely symbolic of a number of disk drives that might be accommodated by computer 58. Typically, these might be one or more of the following: a floppy disk drive 69, a hard disk drive (not shown), and a CD ROM or digital video disk, as indicated by the slot at 70. The number and type of drives varies, typically with different computer configurations. Disk drives 69, 70 are, in fact, options, and for space considerations, may be omitted from the computer system used in conjunction with the processes described herein.

Computer 58 also has a display 71 upon which information may be displayed. The display is optional for the computer used in conjunction with the system described herein. A keyboard 72 and/or a pointing device 73, such as a mouse 73, may be provided as input devices to interface with central processing unit 68. To increase input efficiency, keyboard 72 may be supplemented or replaced with a scanner, card reader, or other data input device. The pointing device 73 may be a mouse, touch pad control device, track ball device, or any other type of pointing device.

Alternatively, referring to FIG. 26, computer 58 may also include a CD ROM reader 95 and CD recorder 96, which are interconnected by a bus 97 along with other peripheral devices 98 supported by the bus structure and protocol. Bus 97 serves as the main information highway interconnecting other components of the computer. It is connected via an interface 99 to the computer 58.

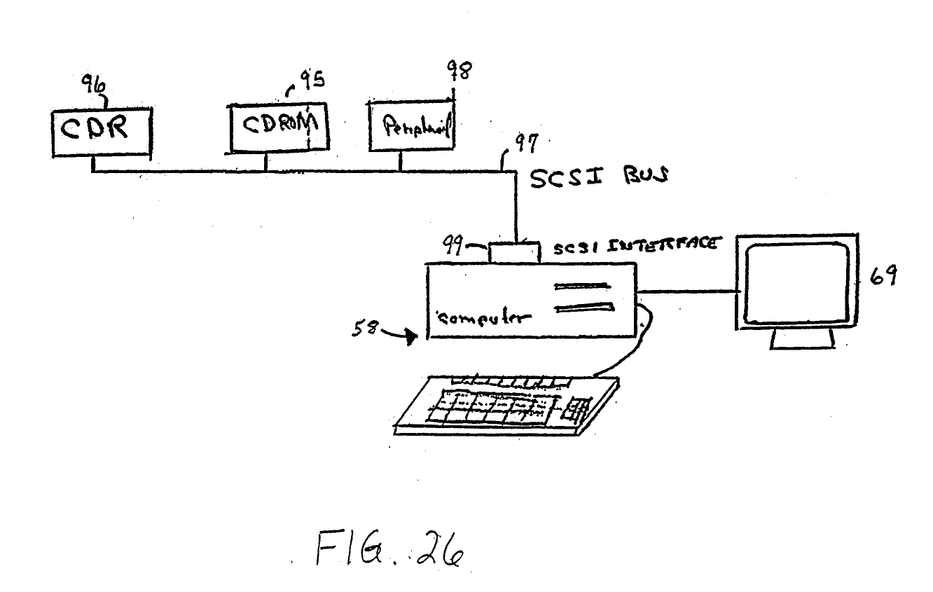

FIG. 25 illustrates a block diagram of the internal hardware of the computer of FIG. 24. CPU 75 is the central processing unit of the system, performing calculations and logic operations required to execute a program. Read only memory (ROM) 76 and random access memory (RAM) 77 constitute the main memory of the computer. Disk controller 78 interfaces one or more disk drives to the system bus 74. These disk drives may be floppy disk drives such as 79, or CD ROM or DVD (digital video/versatile disk) drives, as at 80, or internal or external hard drives 81. As previously indicated these various disk drives and disk controllers are optional devices.

A display interface 82 permits information from bus 74 to be displayed on the display 83. Again, as indicated, the display 83 is an optional accessory for a central or remote computer in the communication network, as are infrared receiver 88 and transmitter 89. Communication with external devices occurs using communications port 84.

In addition to the standard components of the computer, the computer may also include an interface 85, which allows for data input through the keyboard 86 or pointing device, such as a mouse 87.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As one example, the system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, and/or any other method of communicating between computers and/or users. Moreover, the processing could be controlled by a software program on one or more computer systems or processors, or could even be partially or wholly implemented in hardware.

The user interfaces may be developed in connection with an HTML display format. Although HTML is utilized in the illustrated examples, it is possible to utilize alternative technology for displaying information, obtaining user instructions and for providing user interfaces. The invention has been discussed in connection with particular examples. However, the principles apply equally to other examples and/or realizations. Naturally, the relevant data may differ, as appropriate.

Further, this invention has been discussed in certain examples as if it is made available to a single user. The invention may be used by numerous users, if preferred. The system used in connection with the invention may rely on the integration of various components including, as appropriate and/or if desired, hardware and software servers, database engines, and/or other content providers. The configuration may be, preferably, network-based and uses the Internet as a primary interface with the user.

The system according to one or more embodiments of the invention may store collected information and/or indexes to information in a database. An appropriate database may be on a standard server, for example, a small Sun™ Sparc™ or other remote location. The information may, for example, optionally be stored on a platform that may, for example, be UNIX-based. The various databases maybe in, for example, a UNIX format, but other standard data formats may be used.

Although the computer system in FIG. 3 is illustrated as having a single host computer and single remote computer, the system according to one or more embodiments of the invention is optionally suitably equipped with a multitude or combination of processors or storage devices. For example, the host and/or remote computer may be replaced by, or combined with, any suitable processing system operative in accordance with the principles of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on floppy disk, provided on CD Rom, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an interpretive environment such as Java and transported to multiple destinations to various users.

The many features and advantages of the embodiments of the present invention are apparent from the detail specification, and thus, it is intended by the appended claims to cover all such features and advantages of the invention that fall within the true spirit and scope of the invention. Further, since numerous modifications and variations were readily occurred to those skilled in the art, it is not desired to limit the invention to the exact construction and operation illustrated and described, and accordingly, all suitable modifications and equivalents maybe resorted to, falling within the scope of the invention.

What is claimed is:

1. A computer-based slidekit presentation preparation method for allowing a user to at least one of preview and select, at a user's local computer, one or more previously provided slides and slidekits available at another computer for incorporation into a presentation, the user including at least one of physicians and healthcare providers, the another computer including a folder for the user for storing bookmarks and references to the slides and the slidekits selected by the user, comprising the at least one of the sequential, non-sequential and sequence independent steps of:
(A) providing, on the another computer, a plurality of slidekits, each of the plurality of slidekits having a plurality of slides related to a topic, each of the plurality of slidekits being assigned to at least one category;
(B) displaying, responsive to a first user request, on the local computer communicating with the another computer, information representing said at least one category;
(C) displaying, responsive to a first user selection of said at least one category, a list of first information representing each of the plurality of slidekits assigned to the first user selection;
(D) displaying, responsive to a second user selection of one of the plurality of slidekits, second information representing at least a first one of the plurality of slides in the second user selection;
(E) displaying, responsive to a third user selection of at least one of the plurality of slides, third information representing the third user selection;
(F) saving, responsive to a fourth user selection, a reference location to the at least one of the selected slide and the selected slidekit, to a folder assigned to the user, on the another computer;
(G) saving, responsive to a second user request on the local computer, at least one bookmark into the user's folder maintained on the another computer; and
(H) displaying, responsive to a third user request to view the user's folder, information characterizing the user's folder including a list of folders and at least one of the bookmarks contained therein.

2. The method of claim 1, wherein the topic is a medical topic.

3. The method of claim 1, wherein each of the plurality of slides includes a view image, a title, speaker notes, and a thumbnail image.

4. The method of claim 1, wherein said sending includes compressing and downloading the at least one of the selected slide and the selected slidekit

5. The method of claim 1, further comprising the step of sending, responsive to a fifth user selection, at least one of the selected slide and the selected slidekit, from the another computer to the local computer.

6. The method of claim 1, further comprising the step of ensuring, responsive to a requested initiated by the user in at least one of said steps (A) to (G), that the user is currently logged in and registered to the another computer as at least one of a physician and healthcare provider.

7. A computer-based slidekit presentation preparation method for allowing a user to at least one of preview and select, at a user's local computer, one or more previously provided slides and slidekits available at another computer for incorporation into a presentation, the user including at least one of physicians and healthcare providers, the another computer including a folder for the user for storing bookmarks and references to the slides and the slidekits selected by the user, comprising the at least one of the sequential, non-sequential and sequence independent steps of:
(A) providing, on the another computer, a plurality of slidekits, each of the plurality of slidekits having a plurality of slides related to a medical topic and a title reflecting the medical topic; each of the plurality of slides including a view image, a title, speaker notes, and a thumbnail image; and each of the plurality of slidekits being assigned to at least one category;
(B) displaying, responsive to a first user request, on the local computer communicating with the another computer, information representing said at least one category;
(C) displaying, responsive to a first user selection of said at least one category, a list of first information representing each of the plurality of slidekits assigned to the first user selection;
(D) displaying, responsive to a second user selection of one of the plurality of slidekits, second information representing at least a first one of the plurality of slides in the second user selection;
(E) displaying, responsive to a third user selection of at least one of the plurality of slides, third information representing the third user selection;
(F) sending, responsive to a fourth user selection, at least one of the selected slide and the selected slidekit, from the another computer to the local computer, wherein said sending includes compressing and downloading the at least one of the selected slide and the selected slidekit;
(G) saving, responsive to a fifth user selection, a reference location to the at least one of the selected slide and the selected slidekit, to a folder assigned to the user, on the another computer;
(H) ensuring, responsive to a requested initiated by the user in at least one of said steps (A) to (G), that the user is currently logged in and registered to the another computer as at least one of a physician and healthcare provider;
(I) saving, responsive to a second user request on the local computer, at least one bookmark into the user's folder maintained on the another computer; and
(J) displaying, responsive to a third user request to view the user's folder, information characterizing the user's folder including a list of folders and at least one of the bookmarks contained therein.

8. A computer-based slidekit presentation preparation method for allowing a user to at least one of preview and select, at a user's local computer, one or more previously provided slides and slidekits available at another computer for incorporation into a presentation, the user including at least one of physicians and healthcare providers, comprising the at least one of the sequential, non-sequential and sequence independent steps of:
(A) providing, on the another computer, a plurality of slidekits, each of the plurality of slidekits having a plurality of slides related to a medical topic; and each of the plurality of slidekits being assigned to at least one category;
(B) displaying, responsive to a first user request, on the local computer communicating with the another computer, information representing said at least one category;
(C) displaying, responsive to a first user selection of said at least one category, a list of first information representing each of the plurality of slidekits assigned to the first user selection;
(D) displaying, responsive to a second user selection of one of the plurality of slidekits, second information representing at least a first one of the plurality of slides in the second user selection; and
(E) displaying, responsive to a third user selection of at least one of the plurality of slides, third information representing the third user selection.

9. The method of claim 8, wherein each of the plurality of slidekits has a title reflecting the medical topic; and each of the plurality of slides includes a view image, a title, speaker notes, and a thumbnail image.

10. The method of claim 8, further comprising the step of sending, responsive to a fourth user selection, at least one of the selected slide and the selected slidekit, from the another computer to the local computer.

11. The method of claim 10, wherein said sending includes compressing and downloading the at least one of the selected slide and the selected slidekit.

12. The method of claim 8, wherein the another computer includes a folder for the user for storing bookmarks and references to the slides and the slidekits selected by the user, further comprising the step of saving, responsive to a fifth user selection, a reference location to the at least one of the selected slide and the selected slidekit, to a folder assigned to the user, on the another computer.

13. The method of claim 8, further comprising the step of ensuring, responsive to a requested initiated by the user in at least one of said steps (A) to (E), that the user is currently logged in and registered to the another computer as at least one of a physician and healthcare provider.

14. The method of claim 12, further comprising the step of saving, responsive to a second user request on the local computer, at least one bookmark into the user's folder maintained on the another computer.

15. The method of claim 12, further comprising the step of displaying, responsive to a third user request to view the user's folder, information characterizing the user's folder including a list of folders and at least one of the bookmarks contained therein.

16. A computer-based slidekit presentation preparation system for allowing a user to at least one of preview and select, at a user's local computer, one or more previously provided slides and slidekits available at another computer for incorporation into a presentation, the user including at least one of physicians and healthcare providers, comprising:
(A) a plurality of slidekits on the another computer, each of the plurality of slidekits having a plurality of slides related to a medical topic; and each of the plurality of slidekits being assigned to at least one category;
(B) a first display, responsive to a first user request, on the local computer communicating with the another computer, of information representing said at least one category;
(C) a second display, responsive to a first user selection of said at least one category, of a list of first information representing each of the plurality of slidekits assigned to the first user selection;
(D) a third display, responsive to a second user selection of one of the plurality of slidekits, of second information representing at least a first one of the plurality of slides in the second user selection; and
(E) a fourth display, responsive to a third user selection of at least one of the plurality of slides, of third information representing the third user selection.

17. The system of claim 16, wherein each of the plurality of slidekits has a title reflecting the medical topic; and each of the plurality of slides includes a view image, a title, speaker notes, and a thumbnail image.

18. The system of claim 16, further comprising a transmission, responsive to a fourth user selection, of at least one of the selected slide and the selected slidekit, from the another computer to the local computer.

19. The system of claim 18, wherein said at least one of the selected slide and the selected slidekit in said transmission is compressed and downloaded.

20. The system of claim 16, wherein the another computer includes a folder for the user for storing bookmarks and references to the slides and the slidekits selected by the user, further comprising, responsive to a fifth user selection, a reference location to the at least one of the selected slide and the selected slidekit, saved to a folder assigned to the user, on the another computer.

21. The system of claim 16, further comprising a module for ensuring, responsive to a requested initiated by the user, that the user is currently logged in and registered to the another computer as at least one of a physician and healthcare provider.

22. The system of claim 20, further comprising, responsive to a second user request on the local computer, at least one bookmark saved into the user's folder maintained on the another computer.

23. The system of claim 20, further comprising a fifth display, responsive to a third user request to view the user's folder, of information characterizing the user's folder including a list of folders and at least one of the bookmarks contained therein.

24. A computer-based slidekit presentation preparation system for allowing a user to at least one of preview and select, at a user's local computer, one or more previously provided slides and slidekits available at another computer for incorporation into a presentation, the user including at least one of physicians and healthcare providers, comprising:
(A) a plurality of slidekits on the another computer, each of the plurality of slidekits having a plurality of slides related to a medical topic; and each of the plurality of slidekits being assigned to at least one category; wherein each of the plurality of slidekits has a title reflecting the medical topic; and each of the plurality of slides includes a view image, a title, speaker notes, and a thumbnail image;
(B) a first display, responsive to a first user request, on the local computer communicating with the another computer, of information representing said at least one category;
(C) a second display, responsive to a first user selection of said at least one category, of a list of first information representing each of the plurality of slidekits assigned to the first user selection;
(D) a third display, responsive to a second user selection of one of the plurality of slidekits, of second information representing at least a first one of the plurality of slides in the second user selection;
(E) a fourth display, responsive to a third user selection of at least one of the plurality of slides, of third information representing the third user selection;
(F) a transmission, responsive to a fourth user selection, of at least one of the selected slide and the selected slidekit, from the another computer to the local computer; wherein said at least one of the selected slide and the selected slidekit in said transmission is compressed and downloaded;
(G) wherein the another computer includes a folder for the user for storing bookmarks and references to the slides and the slidekits selected by the user, further comprising, responsive to a fifth user selection, a reference location to the at least one of the selected slide and the selected slidekit, saved to a folder assigned to the user, on the another computer; and responsive to a second user request on the local computer, at least one bookmark saved into the user's folder maintained on the another computer;
(H) a module for ensuring, responsive to a requested initiated by the user, that the user is currently logged in and registered to the another computer as at least one of a physician and healthcare provider; and
(I) a fifth display, responsive to a third user request to view the user's folder, of information characterizing the user's folder including a list of folders and at least one of the bookmarks contained therein.

25. A computer-based slidekit presentation preparation system for allowing a user to at least one of preview and select, at a user's local computer, one or more previously provided slides and slidekits available at another computer for incorporation into a presentation, the user including at least one of physicians and healthcare providers, comprising:
(A) means for providing, on the another computer, a plurality of slidekits, each of the plurality of slidekits having a plurality of slides related to a medical topic; and each of the plurality of slidekits being assigned to at least one category;
(B) means for displaying, responsive to a first user request, on the local computer communicating with the another computer, information representing said at least one category;
(C) means for displaying, responsive to a first user selection of said at least one category, a list of first information representing each of the plurality of slidekits assigned to the first user selection;
(D) means for displaying, responsive to a second user selection of one of the plurality of slidekits, second information representing at least a first one of the plurality of slides in the second user selection; and
(E) means for displaying, responsive to a third user selection of at least one of the plurality of slides, third information representing the third user selection.

26. The system of claim 25, wherein each of the plurality of slidekits has a title reflecting the medical topic; and each of the plurality of slides includes a view image, a title, speaker notes, and a thumbnail image.

27. The system of claim 25, further comprising means for sending, responsive to a fourth user selection, at least one of the selected slide and the selected slidekit, from the another computer to the local computer.

28. The system of claim 27, wherein said means for sending includes means for compressing and downloading the at least one of the selected slide and the selected slidekit.

29. The system of claim 25, wherein the another computer includes a folder means for storing bookmarks and references to the slides and the slidekits selected by the user, further comprising means for saving, responsive to a fifth user selection, a reference location to the at least one of the selected slide and the selected slidekit, to a folder assigned to the user, on the another computer.

30. The system of claim 25, further comprising means for ensuring, responsive to a requested initiated by the user, that the user is currently logged in and registered to the another computer as at least one of a physician and healthcare provider.

31. The system of claim 29, further comprising means for saving, responsive to a second user request on the local computer, at least one bookmark into the user's folder maintained on the another computer.

32. The system of claim 29, further comprising means for displaying, responsive to a third user request to view the user's folder, information characterizing the user's folder including a list of folders and at least one of the bookmarks contained therein.

33. A computer-based slidekit presentation preparation system for allowing a user to at least one of preview and select, at a user's local computer, one or more previously provided slides and slidekits available at another computer for incorporation into a presentation, the user including at least one of physicians and healthcare providers, the another computer including a folder for the user for storing bookmarks and references to the slides and the slidekits selected by the user, comprising:
(A) means for providing, on the another computer, a plurality of slidekits, each of the plurality of slidekits having a plurality of slides related to a medical topic and a title reflecting the medical topic; each of the plurality of slides including a view image, a title, speaker notes, and a thumbnail image; and each of the plurality of slidekits being assigned to at least one category;
(B) means for displaying, responsive to a first user request, on the local computer communicating with the another computer, information representing said at least one category;
(C) means for displaying, responsive to a first user selection of said at least one category, a list of first information representing each of the plurality of slidekits assigned to the first user selection;
(D) means for displaying, responsive to a second user selection of one of the plurality of slidekits, second information representing at least a first one of the plurality of slides in the second user selection;
(E) means for displaying, responsive to a third user selection of at least one of the plurality of slides, third information representing the third user selection;
(F) means for sending, responsive to a fourth user selection, at least one of the selected slide and the selected slidekit, from the another computer to the local computer, having means for compressing and downloading the at least one of the selected slide and the selected slidekit;
(G) means for saving, responsive to a fifth user selection, a reference location to the at least one of the selected slide and the selected slidekit, to a folder assigned to the user, on the another computer;
(H) means for ensuring, responsive to a requested initiated by the user, that the user is currently logged in and registered to the another computer as at least one of a physician and healthcare provider;
(I) means for saving, responsive to a second user request on the local computer, at least one bookmark into the user's folder maintained on the another computer; and
(J) means for displaying, responsive to a third user request to view the user's folder, information characterizing the user's folder including a list of folders and at least one of the bookmarks contained therein.
